(19) United States
(12) Patent Application Publication
(10) Pub. No.: US 2022/0251399 A1
(43) Pub. Date: Aug. 11, 2022

(54) Variable Color 3D Printer Material Using Reversible Thermochromic Additive

(71) Applicant: Mike Molinari, New London, CT (US)

(72) Inventor: Mike Molinari, New London, CT (US)

(21) Appl. No.: 17/588,845

(22) Filed: Jan. 31, 2022

Related U.S. Application Data
(60) Provisional application No. 63/146,708, filed on Feb. 7, 2021.

(51) Int. Cl. C09D 5/29; B33Y 10/00; B33Y 70/00; B29C 64/118; C09D 5/26

(52) U.S. Cl. CPC C09D 5/29; B33Y 10/00; B29K 2105/0032; B29C 64/118; C09D 5/26; B33Y 70/00

(57) ABSTRACT

A polymeric material that is heated and extruded to build 3D-printed objects has variable and reversible thermochromic properties which enable software-controlled color alteration according to the extrusion temperature of the 3D printer, enabling 3D printing of a single object, in multiple colors, using a stock 3D printer. This color alteration is reversible, allowing the printing material to revert to its original color when it is exposed to a certain temperature range. The embodiment enables stock 3D printers to produce multicolored objects via software control, without requiring printer modifications or the use of ancillary tools. It enables the printing of single objects in multiple colors, using a single stock material.

### TECHNICAL FIELD

The present disclosure relates generally to printing materials used in 3D printing, and more specifically to variable-color 3D printer material using a reversible thermochromic additive.

### BACKGROUND

Three-dimensional (3D) printing is a process in which material is joined or solidified under computer control to create a 3D object, combining materials such as liquid molecules, powder grains or melted filamen to heat and extrude a built object. The printing follows a set of instructions dictated by a 3D model computer program.

Fused deposition modeling (FDM) is a 3D-printing technology that melts and extrudes a plastic or a polymer to create layers that form a 3D object. FDM printers typically deliver plastic stock material from a spool into the 3d printer and out of an extruder (or nozzle.) The printer melts the filament and pushes it through the nozzle, which moves over a platform, building an object layer by layer.

Polycaprolactone (PCL) is a biodegradable polyester with a low melting point (around 60° C.) that is commonly used as a feedstock for 3D minters.

Typical FDM 3D printers operate by extruding a plastic or polymer material in a pattern controlled by a computer to build an object over time by fusing extruded segments of polymer into a solid object. FDM printers typically use a filament material that is heated, in a nozzle assembly, to a particular temperature controlled by a computer. The color of a typical FDM printed object can be changed only by use of multiple print heads, or by changing the fed filament. This means that multiple-color printing requires a more complicated 3D printer, or frequent manual changes of the print material. Common low-cost FDM 3D printers have a single extruder that prints only a single material at a time.

Extrudable plastic or polymer fused deposition modeling (FDM) 3D printer material is any material that can be heated and extruded through a 3D printer to build a 3D object. It comes in the form of filament, powder, pellets, beads or any other shape that can be fed and extruded or bonded with heat.

Some polymers used in 3D printing have color properties that enable the printed object to change with the ambient temperature. These extrudable plastic or polymer materials come in filament, powder, pellets, beads and other shapes that can be readily melted and fed through the nozzle of a 3D printer. Dyes, pigments and other additives comprise the chromatic foundation of these materials, and cause the material to respond to temperature changes with color changes. 3D printer filaments materials include polycaprolactone, ABS, PLA, PC, nylon, PVA, PETG, and carbon fiber.

Thermochromic 3D printing filaments are print materials that change color under varying ambient conditions, similar to the activation of color in liquid-crystal products like mood rings. A color change is sometimes referred to as “activation,” and a color reversion, “deactivation.” These printing filaments cannot change color in the print process; they can change color only after the printing is completed. A printing filament with reversible properties would allow it to be manufactured such that freezing the filament would restore the original color to the material. It could then be restored to ambient temperature, and could be used in printing at specific print-head temperatures to result in changed colors.

Although 3D printers can print objects in more than one color, doing so requires changing out printing materials mid-job. The current technology does not adequately enable multicolor 3D printing without the inconvenience of changing the print-heads, manually swapping filament spools or using automated filament-splicing machines.

In typical applications in the state of the art, color changes are usually set to occur once the 3D object has finished printing, with exposure to varying ambient temperatures changing the printed object's color. Color changes may be set to activate when the printed object comes in contact with a warm or cold object. For example, a 3D-printed cup holder will change color once a cup of hot beverage is placed in it. It will revert to its original color once the beverage has cooled.

Slicing a 3D model is the process by which a computer program takes a 3D model and calculates the individual paths along which the polymer material must be extruded or bonded.

### SUMMARY

A polymeric filament material has reversible thermochromic properties that enables software-controlled color alteration according to the extrusion temperature of a 3D printer. The material enables 3D printing of a single object in multiple colors. This color alteration is reversible, allowing the printing material to revert to its original color when it is exposed to a certain temperature range. The embodiment enables stock 3D printers to produce multicolored objects via software control, without requiring printer modifications or the use of ancillary tools. It enables the printing of single objects in multiple colors, using a single stock material.

The color is programmed by software at time of extrusion by selectively adjusting the hot-end temperature. During printing, as the temperature of the print nozzle changes, the print material's color changes. The embodiment enables printing, for example: a clear material which exposes an underlying print-material color; the original filament color that results when exposed to a hot-end temperature; and a changed filament color when exposed to a different hot-end temperature. The embodiment enables, in another example, a colored filament to change to transparent when the filament is exposed to a certain temperature; or the reverse, i.e., a colored filament printing at its original color when exposed to a different temperature.

Rather than ambient temperature, the embodiment's color depends on the temperature at which it is extruded. It is reversible in that it can be changed back to its original color by exposing it to a relatively colder temperature.

In the current state of the art, a 3D-printed object may be printed using more than one filament material to result in a printed object that can change color according to ambient temperature. The instant invention enables printing an object in multiple colors using a single print stock.

FDM printers in the state of the art use filament material heated in the printer's nozzle assembly to a temperature instructed by a computer. Typically the printed object's color can be changed only by the use of multiple print heads or by changing the feed filament. The necessity of changing printing material slows the printing process. Most FDM printers have only a single extruder, printing with one material at a time, The instant invention enables printing an object in multiple colors using one print head, and without the need to change print material.

In an example embodiment, the present disclosure is an FDM 3D printer material with a reversible thermochromic additive that enables the material to change color according to the extrusion temperature, enabling printing of one part in more than one color.

By selecting a specific extrusion temperature, a 3D printer may activate or deactivate the reversible thermochromic dye, pigment or other additive that is part of the embodiment.

The material activates at a certain extrusion temperature, allowing selection of color at the time of printing. A 3D printer may be set to print at a lower temperature to get one color and a higher temperature to get another color, without stopping the print job to make the hardware changes normally associated with color changes.

At any time, upon temperature change, the material can revert to its original color; this is what makes it “reversible.” It can change color again and repeatedly when exposed to additional temperature changes. This reversible quality also facilitates its manufacture. Because any thermochromic printing material is subject to temperature changes during the manufacturing process, it is subject to degradation if the temperature exceeds the activation temperature of the colorant/additive. The material's reversible nature leaves room for such error in manufacturing. The material could be reset by exposing it to a relatively colder temperature, and it can be reused and reactivated repeatedly, mitigating the waste of erroneously altered thermochromic print material.

The embodiment uses a reversible thermochromic additive (which might be a dye, pigment or other type of colorant) that activates at a certain temperature range and deactivates (i.e., returns to its original color) at another temperature range.

The technology is similar to that used in erasable pens. These use ink that loses its color when heated above 60° C. and returns to its original color when cooled to negative 5° C. In the instant invention the applied technology yields unexpected results in a new field of invention.

The embodiment also enables printing in more than two final colors. This is done by using more than one reversible thermochromic material, and by varying the exposure of these materials to more than one activation temperature.

Typical FDM 3D printers operate by extruding a plastic or polymer material in a pattern controlled by a computer to build an object over time by fusing extruded segments of polymer into a solid object. FDM printers typically use a filament material that is heated in a nozzle assembly to a particular temperature. The color of a typical FDM printed object can be changed only by use of multiple print heads, or by changing the fed filament. This means that printing more than one color requires a more complicated 3D printer, or that manual material changes are required. Common low-cost FDM 3D printers have a single extruder, printing with only a single material at a time. Common low-cost 3D printers can change the extruder temperature during printing. The reversible thermochromic polymer filament of the disclosed embodiment uses this common feature to achieve a wholly different effect: that of 3D printing of varying colors, in one print job, according to changing extruder temperatures.

In manufacturing, a yellow filament and add a red additive would make an orange embodiment. The color is orange at the ambient temperature.

During printing, at a specified temperature, the additive turns the orange filament yellow, because the additive has effectively erased the red of the additive.

For example, the thermochromic print material might originate at a filament color ABC, in which A=red additive, B=blue additive, C=yellow base color. A user would have three color choices at time of printing:

1. No color change. A user would simply print at a temperature range that does not activate the additives.

2. Color-change 1. Print it at a hot-end temp>=N. That temperature is the activation temperature for color additive A. The result is that it erases color A, leaving color BC, which in this case would be green.

3. Color-change 2. Print at an activation temp>=X (given X is a higher temp than N). That temperature is the activation temperature for color additive B, but also for A, because it is inclusive of the lower temperatures. Printing at this temperature effectively erases colors A+B, leaving color C (in this case, yellow, the base filament color).

The three possible colors would be ABC, BC or C. AC would not be a color because the temperature that activates B has also activated A.

All of the above is reversible during printing. For example, once extruded at color C, one could lower the temperature and print color BC, or lower the temperature even more and get color ABC. One could raise the color again further to get color C.

One skilled in the art understands that using a print material with many additives can yield many color combinations, as well as the reverse of the combinations.

In the above example, the embodiment causes a color to change to transparent. In a separate iteration, a different additive has the opposite effect, causing a color to change from transparent to a color. As with the first iteration, the action is simply a color change that occurs at a certain temperature.

One skilled in the art understands that one could mix and match these reversible materials to result in various color combinations.

Using the disclosed material, one may print a 3D-printed object and include, for example, markings of various colors to make artistic designs or to indicate text labels or mounting locations.

The base polymer material of the instant invention has a temperature range at which it may be heated and extruded for the purpose of 3D printing. The colorant component of the instant invention (i.e., the reversible thermochromic additive) is formulated to activate within the same temperature range of that polymer. The colorant and polymer are blended and made into a filament in the same manner as standard 3D-printing filaments. Before printing, the blended material can be exposed to a relatively low temperature. This sets the base color. If the blended material becomes exposed to a relatively high temperature, changing the color, the base color can be subsequently restored by exposure again to a low temperature.

Temperature variation used to activate the color changes in polymer material may also be applied to powder-bed, laser-sintering type 3D printers. With these types of printers, varying the temperature or intensity of laser power (used in melting and binding the powder into a finished 3D print) can be similarly applied to change color in parts of the printed piece.

It is possible to recycle 3D-printed objects back into usable stock material by using the above temperature exposure to restore the material's base color. It is this reversible thermochromic property that enables repeated re-use in producing multicolor objects.

Slicing a 3D model is the process by which a computer program takes a 3D model and calculates the individual paths along which the polymer material must be extruded or bonded. A slicing program capable of multicolor object-slicing would be used to develop the tool paths for the object. When a change of color is required, instructions for the 3D printer to change the nozzle temperature would be followed to enable the 3D printer to make use of the reversible thermochromic material.

In an example embodiment, an off-the-shelf polycaprolactone polymer having a melt temperature of minimum 42° C. and maximum of 80° C. might be blended with a thermochromic ink that has a cold-activation temperature of −10° C. and a hot-activation temperature of 60° C.

The reversible thermochromic additive of the instant invention might have, for example, a hot-activation temperature above the 42° C. melt temperature of the example polymer, and below the 80° C. maximum. Printing in this range at an example printing temperature of 52° C. would produce a base color. Printing in this range at an example printing temperature of 65° C. would result in an alternate, hot-activated color.

### BRIEF DESCRIPTION OF THE DRAWINGS

FIG. 1 is a front perspective view of a multicolored 3D object, printed using the embodiment.

FIG. 2 is a front view of a polymer extruded without an activated color change.

FIG. 3 is a front view of a polymer extruded with an activated color change.

### DETAILED DESCRIPTION

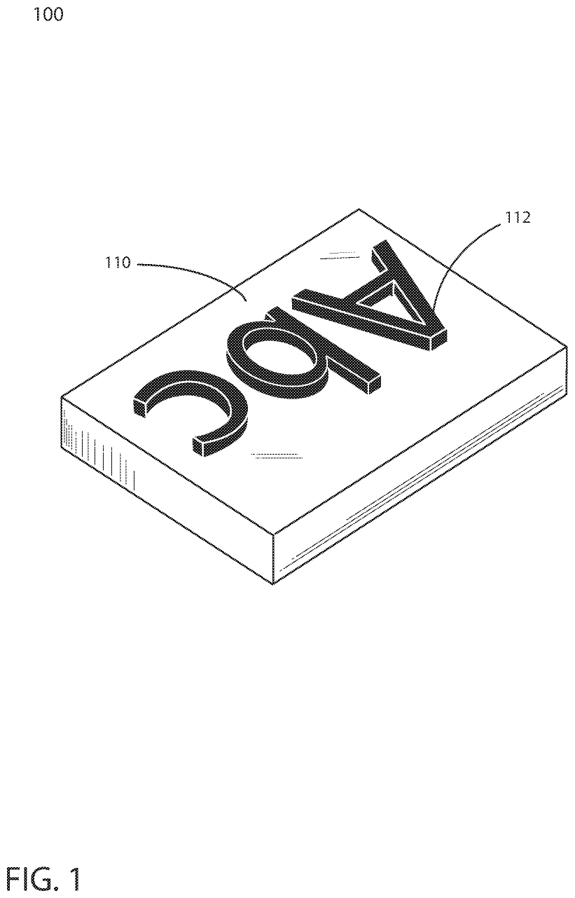

In FIG. 1, a multicolor 3D object is shown printed using the embodiment. The print material's color is programmed by software at time of extrusion by selectively adjusting the 3D printer's hot-end temperature. During printing, as the temperature of the print nozzle changes, the print material's color changes. Lettering 112 is printed at a programmed temperature to produce a color. A base 110 is printed at a different programmed temperature to produce a clear base.

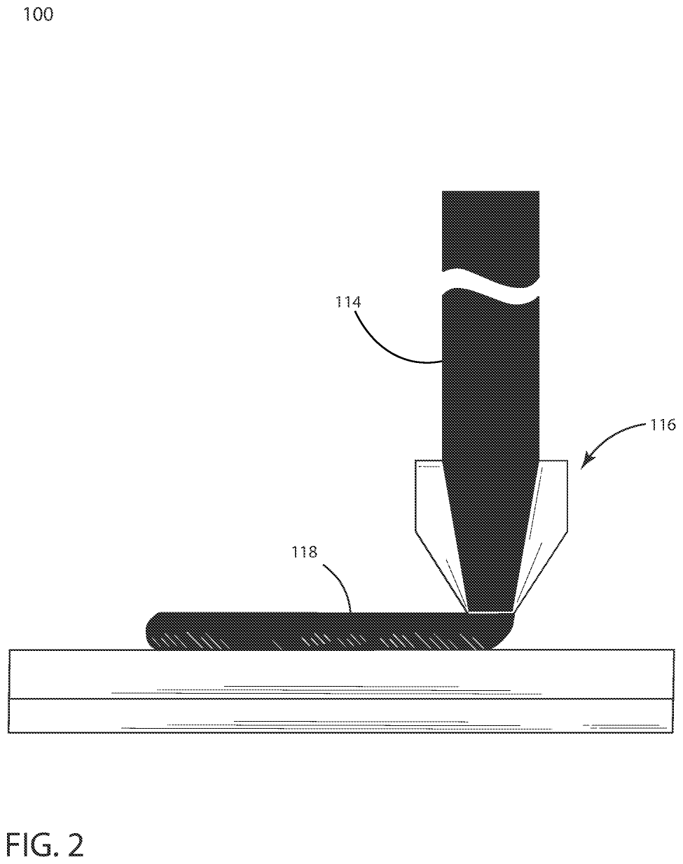

FIG. 2 shows a detail view of the printing of, for example, the lettering of FIG. 1. In magnified view, it shows an extruded length of a polymer 118 produced by a filament of the embodiment 114, printed at a hot-end 116 temperature that does not activate a color change.

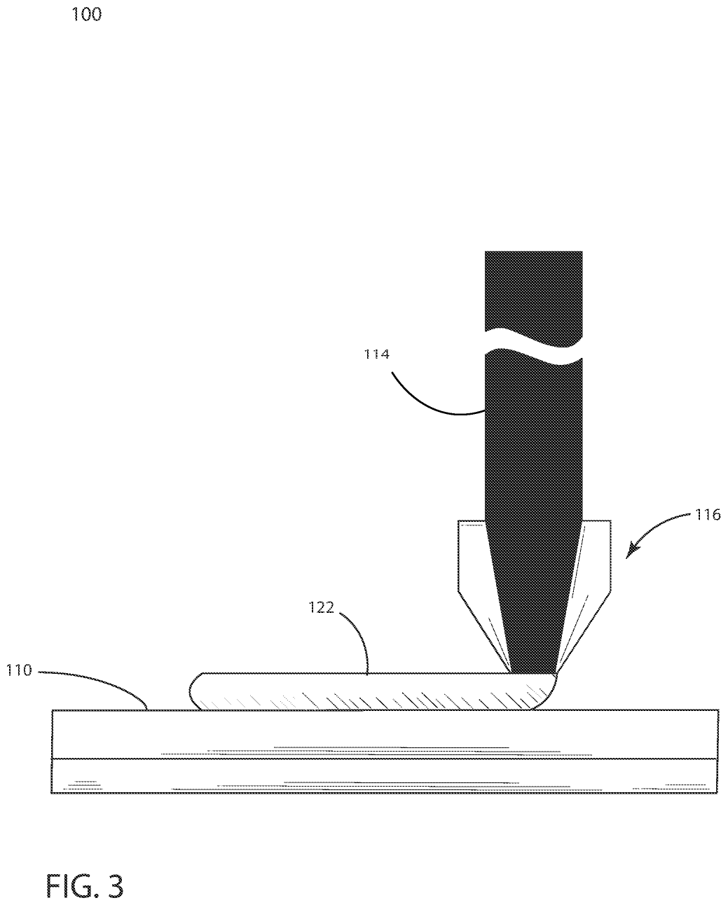

FIG. 3 shows another detail view of the printing of, for example, a different layer of polymer 122 produced by the embodiment 114. In this case the polymer is extruded with an activated color change; the temperature of the print head's hot end 116 has been set to output the activated color. In this case the embodiment 114 is activated and the extruded polymer 122 changes color.

1. A polymeric material for 3D printing comprising:
a polymer; and
at least one thermochromic additive; and
said polymer having a predetermined melt-temperature range; wherein printing with the polymeric material yields at least a first color when printed at a temperature in the lower melt-temperature range, and yields at least a second color when printed at a temperature in the higher melt-temperature range.

2. The polymeric material for 3D printing of claim 1 wherein:
said at least one thermochromic additive is reversible and returns to its original color when cooled below a predetermined cold-activation temperature.

3. The polymeric material for 3D printing of claim 1 further comprising:
said at least one thermochromic additive has a hot-activation temperature within said predetermined melt temperature range; wherein
printing the polymeric material yields at least a first color when printed at a temperature below said hot-activation temperature, and yields at least a second color when printed at a temperature above said hot-activation temperature, providing a single printed object of one polymeric material in at least two colors.

4. The polymeric material for 3D printing of claim 3 wherein:
said polymer is a first color; and
a first of said at least one thermochromic additive is of second color; and
a second of said at least one thermochromic additive is of a third color; and
said first of said at least one thermochromic additive has a first hot activation point that is different than a that of said second of said at least one thermochromic additive which has a second hot activation point; wherein
printing said polymeric material at a temperature not in the range of said first hot activation point or said second hot activation point yields said first color; and printing said polymeric material at a temperature in the range of said first hot activation point yields a combination of said first color and said second color; and printing said polymeric material at a temperature in the range of said second hot activation point yields a combination of said first color and said third color.

5. The polymeric material for 3D printing of claim 3 wherein:
one of said at least one thermochromic additives is transparent at temperatures below said hot-activation temperature and is a color at temperatures above said hot activation temperature.

6. The polymeric material for 3D printing of claim 3 wherein:
one of said at least one thermochromic additives is a color at temperatures below said hot-activation temperature and is transparent at temperatures above said hot activation temperature.

7. A method of using the polymeric material for 3D printing of claim 1, the method comprising:
providing a 3D printer; and
loading said 3D printer with the polymeric material of claim 1; and
adjusting the temperature of a print head on said provided 3D printer to at least a first temperature within said predetermined melt temperature range; and
printing at least a first portion of an object in said at least said first color; and
adjusting the temperature of said print head on said provided 3D printer to at least a second temperature within said predetermined melt temperature range; and
printing at least a second portion of an object in said at least said second color; wherein
the resulting printed object comprises at least two colors.

8. The method of using the polymeric material of claim 7 further comprising:
cooling said resulting printed object below a predetermined cold-activation temperature, resulting in a printed object of one color.

9. The method of using the polymeric material of claim 7 further comprising:
adjusting the temperature of said print head on said provided 3D printer to at least a third temperature; and
printing at least a third portion of said object.

10. A method of manufacturing the polymeric material for 3D printing of claim 3, the method comprising:
combining a polymer with at least one thermochromic additive; and
forming combined polymer and at least one thermochromic additive(s) into a material; and
chilling said material; wherein
printing with said material yields at least a first color when printed at a temperature below said hot activation temperature and within the melt-temperature range, and yields at least a second color when printed at a temperature above said hot activation temperature and within said melt-temperature range.
